(19) United States
(12) Patent Application Publication
(10) Pub. No.: US 2015/0294012 A1
(43) Pub. Date: Oct. 15, 2015

(54) DISPLAYING A REPRESENTATIVE ITEM FOR A COLLECTION OF ITEMS

(71) Applicant: INTERNATIONAL BUSINESS MACHINES CORPORATION, Armonk, NY (US)

(72) Inventors: Lisa Seacat DeLuca, Baltimore, MD (US); Ido Guy, Haifa (IL); Nili Guy, Haifa (IL); Boaz Mizrachi, Haifa (IL)

(73) Assignee: INTERNATIONAL BUSINESS MACHINES CORPORATION, Armonk, NY (US)

(21) Appl. No.: 14/630,914

(22) Filed: Feb. 25, 2015

Related U.S. Application Data
(63) Continuation of application No. 14/252,539, filed on Apr. 14, 2014.

(51) Int. Cl. G06F 17/30

(52) U.S. Cl. CPC G06F 17/30867; G06F 17/30876; G06F 17/30528

(57) ABSTRACT

Displaying a representative item for a collection of items includes obtaining, from at least one source, a history of interests associated with a user, analyzing the history of interests associated with the user to determine preference criteria for the user, identifying, based on the preference criteria for the user, a representative item for a collection of items, and displaying, to the user, the representative item.

### BACKGROUND

The present invention relates to displaying a representative item, and more specifically, to displaying a representative item for a collection of items.

A collection of items, such a number of images, may be displayed on a social media website, a smart phone, an application, among others. The collection of items may be related based on a common date, a common topic, a common themes, other relationships, or combinations thereof. Further, a representative item may be selected to represent all the items associated with the collection of items.

### BRIEF SUMMARY

A method for displaying a representative item for a collection of items includes obtaining, from at least one source, a history of interests associated with a user, analyzing the history of interests associated with the user to determine preference criteria for the user, identifying, based on the preference criteria for the user, a representative item for a collection of items, and displaying, to the user, the representative item.

A system for displaying a representative item for a collection of items includes an obtaining engine to obtain, from at least one source, a history of interests associated with a user, an analyzing engine to analyze the history of interests associated with the user to determine preference criteria for the user, an identifying engine to identify, based on the preference criteria for the user, a representative item for a collection of items, a representative item displaying engine to display, to the user, the representative item, a changing engine to change the representative item to a different representative item for the collection of items to allow the different representative item to be displayed to the user, and a different representative item displaying engine to display, to a different user, a different representative item for the collection of items.

A computer program product includes a computer readable storage medium, the computer readable storage medium having computer readable program code embodied therewith. The computer readable program code having computer readable program code to analyze a history of interests associated with a user to determine preference criteria for the user, identify, based on the preference criteria for the user, a representative item for a collection of items, and display, to the user, the representative item.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of an example of a system for displaying a representative item for a collection of items, according to one example of principles described herein.

FIG. 2A is a diagram of an example of displaying a representative item for a collection of items to a user, according to one example of principles described herein.

FIG. 2B is a diagram of an example of displaying a representative item for a collection of items to a user, according to one example of principles described herein.

FIG. 3A is a diagram of an example of displaying a representative item for a collection of items to a different user, according to one example of principles described herein.

FIG. 3B is a diagram of an example of displaying a representative item for a collection of items to a user, according to one example of principles described herein.

FIG. 4 is a diagram of an example of an interest library, according to the principles described herein.

FIG. 5 is a flowchart of an example of a method for displaying a representative item for a collection of items, according to one example of principles described herein.

FIG. 6 is a flowchart of an example of a method for displaying a representative item for a collection of items, according to one example of principles described herein.

FIG. 7 is a diagram of an example of a displaying system, according to one example of principles described herein.

FIG. 8 is a diagram of an example of a displaying system, according to one example of principles described herein.

Throughout the drawings, identical reference numbers designate similar, but not necessarily identical, elements.

### DETAILED DESCRIPTION

The present specification describes a method and system for displaying a representative item for a collection of items such that the representative item is tailored to the interests of the user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, a representative item may be selected to represent all the items associated with the collection of items. Techniques for selecting a representative item for a collection of items are focused on image or video processing that would detect an item, that best represent the collection of items as a whole, to be the representative item. For example, a collection of items may include eight images of a red sports car and two images of the owner of the red sports car. In this example, since there are more images of the car than the owner, techniques for selecting a representative item for the collection of items may include selecting the best image of the red sports car to be the representative item.

However, the techniques do not take into account the individual user who views the collection of items. For example, a user viewing the collection of items may be more interested in the owner than the red sports car. As a result, the user is less likely to view the collection of items if the representative item is an image of the red sports car.

The principles described herein include a method for displaying a representative item for a collection of items. In this example, the method includes obtaining, from at least one source, a history of interests associated with a user, analyzing the history of interests associated with the user to determine preference criteria for the user, identifying, based on the preference criteria for the user, a representative item for a collection of items, and displaying, to the user, the representative item. Such a method allows an item, associated with the collection of items and that is of interest to the user, to be displayed as a representative item. As a result, the representative item for the collection of items is tailored to suit the interest of individual users. Thus, attracting the user to the collection of items.

Further, the method can include changing the representative item to a different representative item for the collection of items to allow the different representative item to be displayed to the user. More information about changing the representative item to the different representative item for the collection of items will be described in more detail below.

In the specification and appended claims, the term “item” is meant to be understood broadly as an image, a uniform resource locators (URL), a message, a video, audio, other items, or combinations thereof. In one example, items may be posted by any user, on a social media website, an application, or other places, as a collection of items. The collection of items may be related based on a common date, a common topic, a common themes, other relationships, or combinations thereof. Further, once the collection of items is posted, other users may view the collection of items.

In the specification and appended claims, the term “representative item” is meant to be understood broadly as an item selected from a collection of items that is used to represent the entire collection of items. In one example, the representative item may be an image, a URL, a message, a video, audio, other items, or combinations thereof. As will be described in the specification, the representative item for the collection of items may be different for each user who views the collection of items based on the preference criteria for each user.

In the specification and appended claims, the term “history of interest” is meant to be understood broadly as content that is captured over a specific amount of time by monitoring activity of a user. In one example, the content may include explicit interests of the user, implicit interests of the user, explicit interests of a similar user, implicit interests of the similar user, or combinations thereof.

In the specification and appended claims, the term “preference criteria” is meant to be understood broadly as categorized topics that are associated with the content the history of interest. In one example, an analysis may be performed on the history of interest to determine the preference criteria for a user. Further, the preference criteria indicate that the user is interested in a specific topic.

In the specification and appended claims, the term “source” is meant to be understood broadly as a place where a history of interest may be obtained. In one example, a source may include a social media website, a search engine, other websites, or combinations thereof.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

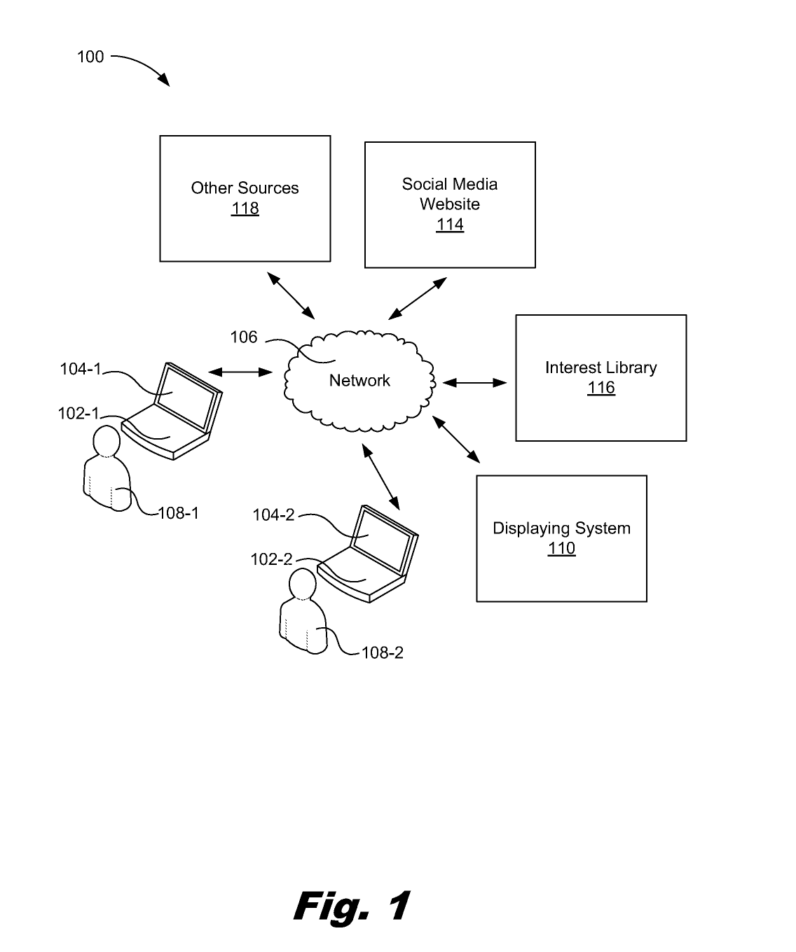

Referring now to the figures, FIG. 1 is a diagram of an example of a system for displaying a representative item for a collection of items, according to one example of principles described herein. As will be described below, a displaying system is in communication with a network to obtain, from at least one source, a history of interests associated with a user. Further, the displaying system identifies, based on preference criteria for the user, a representative item for a collection of items. Further, the displaying system displays, to the user, the representative item.

As illustrated in FIG. 1, the system (100) includes a first user (108-1) and a second user (108-2). In one example, the first user (108-1) and the second user (108-2) may have different interests. The first user (108-1) and the second user (108-2) may express their different interest by accessing a social media website (114) and other sources (118). For example, the first user (108-1) may use a first user device (102-1) to access the social media website (114) or other sources (118) such as a search engine, other websites, or combinations thereof to express their interests by searching for topics, liking posts, commenting on posts, among others. Further, the second user (108-2) may use a second user device (102-1) to access the social media website (114) or other sources (118) such as a search engine, other websites, or combinations thereof to express their interests by searching for topics, liking posts, commenting on posts, among others.

In this example, the social media website (114) includes a number of collections of items that are displayed to the users (108). In one example, the collections of items include a number of related items that are posted to a news feed by other users. For example, a collection of items may include a number of recipes. Another collection of items may include items relating to home decor. In one example, for each of the collections of items a representative item is displayed that represents the collection of items. In this example, the representative items for each collection of items may be displayed to the first user (108-1) via the display (104-1) on the first user device (102-1). Further, the representative items for each collection of items may be displayed to the second user (108-2) via the display (104-2) on the second user device (102-2). As will be described in this specification, the representative items for each of the collection of items may be different for each user (108) who views the collection of items based on the preference criteria for each user (108).

As illustrated in FIG. 1, the system (100) includes a displaying system (110). In one example, the displaying system (110) obtains, from at least one source, a history of interests associated with a user. For example, the first user (108-2). In one example, the source may be the social media website (114), other sources (118), or combinations thereof. As mentioned above, the other sources (118) may include websites such as search engine websites, other social media websites, other websites, other sources, or combinations thereof. Further, the history of interests may be stored, respectively for each user (108) in an interest library (116). More information about the interest library (116) will be described in later parts of this specification. Further, the displaying system (110) obtains a history of interests for the second user (108-2).

The displaying system (110) analyzes the history of interests associated with the user to determine preference criteria for the user. In one example, analyzing the history of interests associated with the user to determine preference criteria for the user includes applying a natural language processing (NLP) to content within the history of interests to characterize the content. In this example, the preference criteria may be determined for the first user (108-1). Further, the displaying system (110) performs a similar analysis for the second user (108-2).

The displaying system (110) further identifies, based on the preference criteria for the user, a representative item for a collection of items. In one example, displaying system (110) further identifies an additional representative item for a collection of items. In this example, the representative item may be identified based on the preference criteria for the first user (108-1). Similarly, a representative item may be identified based on the preference criteria for the second user (108-2).

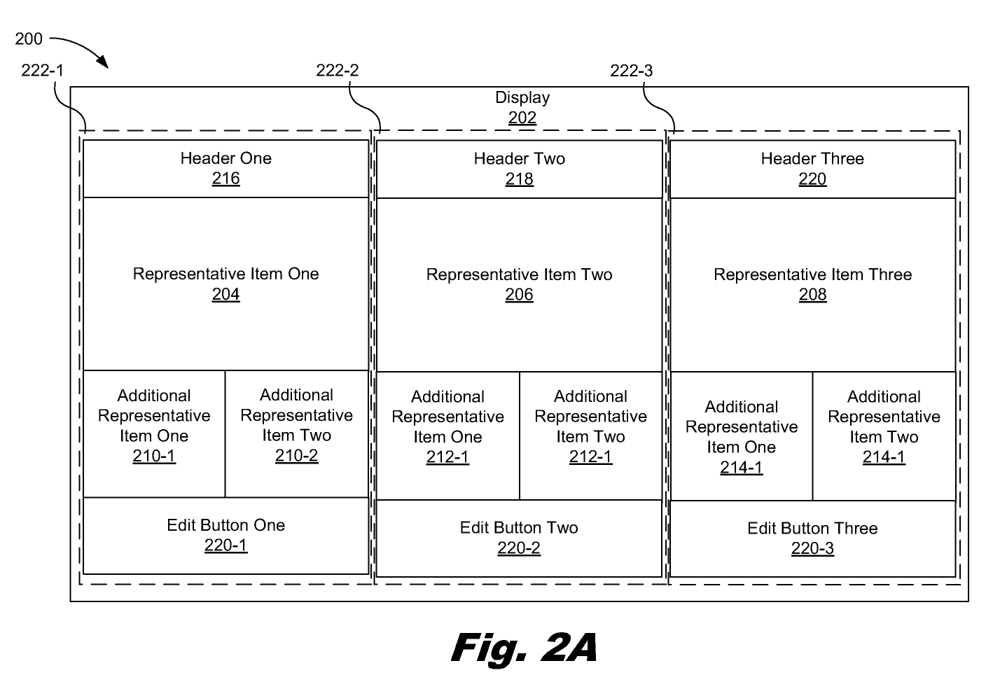

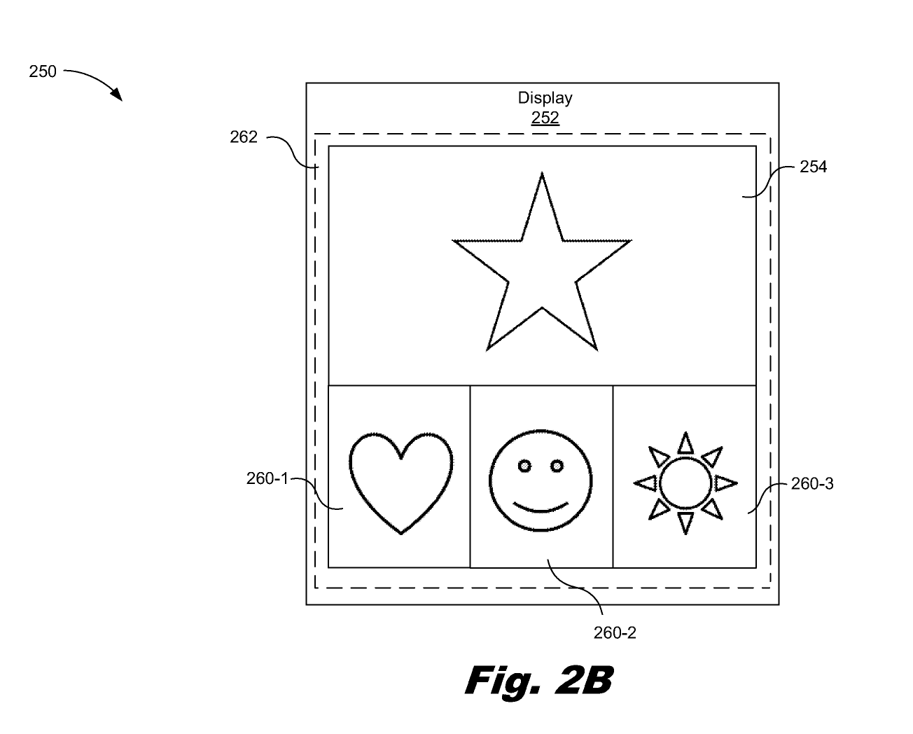

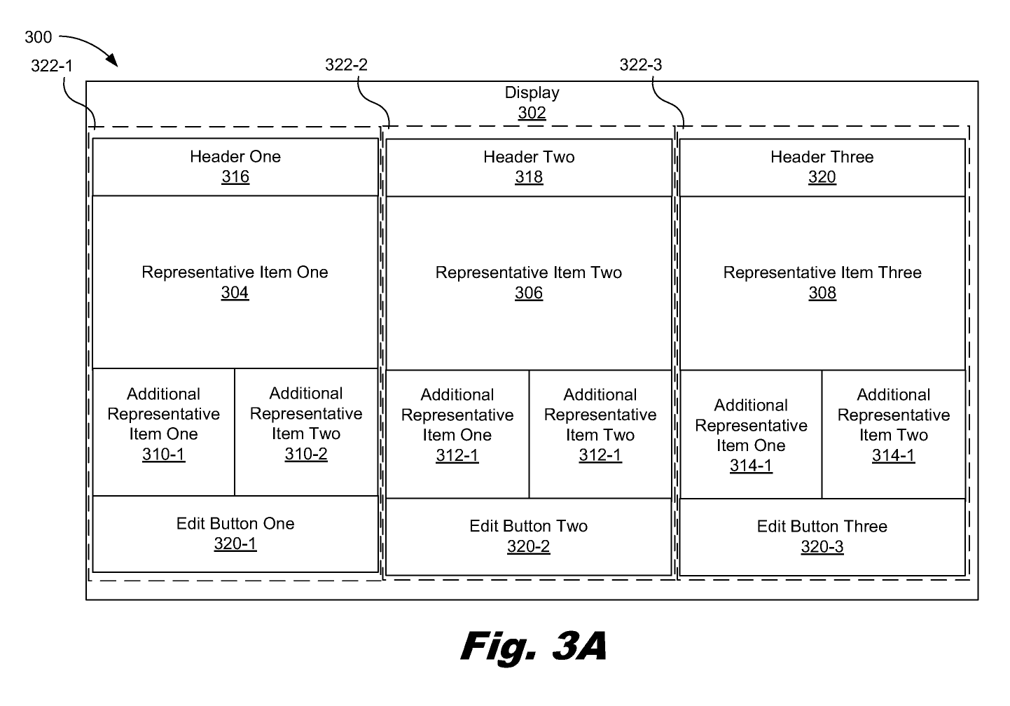

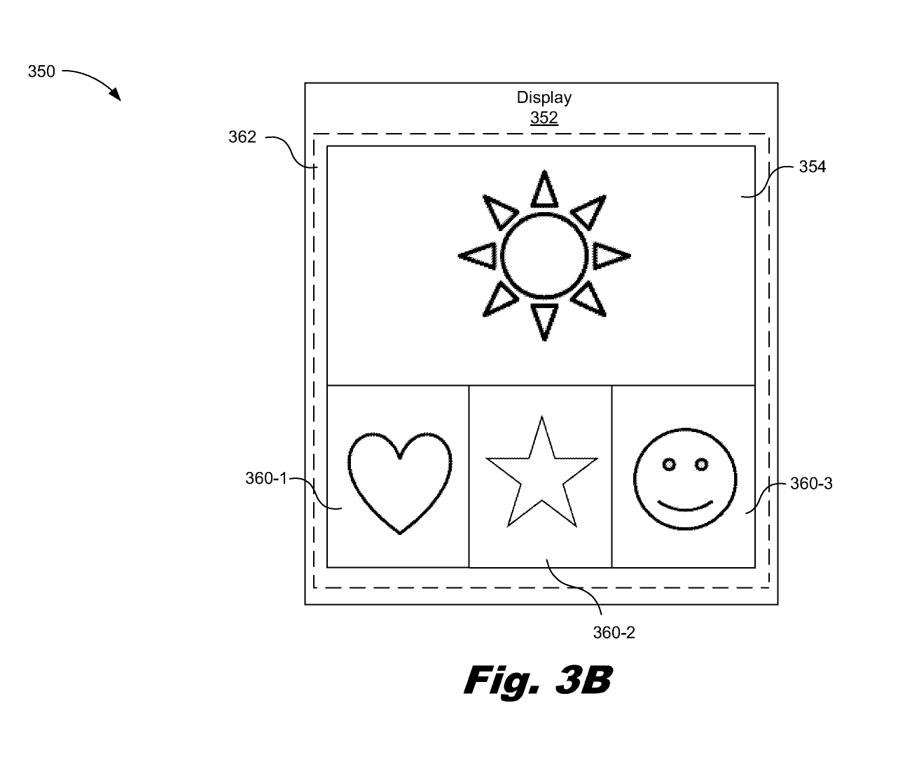

The displaying system (110) further displays, to the user, the representative item. In this example, the representative item may be displayed to the first user (108-1) on the social media website (114). An illustration of what is displayed to the first user (108-1) will be described in FIG. 2A. Further, the displaying system (110) displays, to a different user, such as the second user (108-2), a different representative item for the collection of items. In this example, the displaying system (110) displays, to the different user the different representative item for the collection of items on the social media website (114). In one example, the different representative item for the collection of items is based on preference criteria for the different user. In this example, the different representative item may be displayed to the second user (108-1), based on the preference criteria for the second user (108-2). An illustration of what is displayed to the second user (108-2) will be described in FIG. 3A.

Such a system (100) allows an item associated with the collection of items that is of interest to the user to be displayed as a representative item. As a result, the representative item for the collection of items is tailored to suit the interest of users (108). More information about the displaying system (110) will be described in other parts of this specification.

While this example has been described with reference to two different representative items being displayed to the users, respectively, the representative items may be the same, if the preference criteria are the same for the users. Further, while this example has been described with reference to the system including two users, the system may include any number of users.

Further, while this example has been described with reference to displaying, to the users, representative items for the collection of items on a social media website, the representative items for the collection of items may be displayed anywhere. For example, the representative items for the collection of items may be displayed on an application, on a search engine website, other places, or combinations thereof.

FIG. 2A is a diagram of an example of displaying a representative item from a collection of items to a user, according to one example of principles described herein. As mentioned above, an item associated with the collection of items that may be of interest to the user is displayed as a representative item. A user may click on the representative item to view the other items in the collection of items. As a result, the representative item for the collection of items is tailored to suit the interest of individual users. In FIG. 2A, the term user is to be associated with the first user (108-1) of FIG. 1.

In one example, through analyzing the history of interest of the user, the user just got engaged. As a result, the preference criteria for the user indicate that the user is interested in topics about weddings, marriage, wedding rings, among others.

As illustrated in FIG. 2A, a display (202) is used to display a number of boards (222). In this example, three boards, namely board one (222-1) board two (222-3) and board Three (222-3) are displayed. The boards (222) represent a collection of items that are displayed to a user as well as additional information.

In this example, board one (222-1) includes header one (216). Header one (216) corresponds to a topic for board one (222-1). For example, header one (216) may be a title such as photo ideas. Further, board one (222-1) may include representative item one (204). As mentioned above, the displaying system (110) of FIG. 1 identifies, based on the preference criteria for the user, a representative item for a collection of items. As mentioned above, the preference criteria may include topics relating to weddings. If the collection of items includes items relating to weddings and kids, the displaying system of FIG. 1 displays a representative item accordingly. For example, the preference criteria for the user may indicate that the representative item for a collection of items is to be a save the date image because the save the date image relates to the preference criteria for the user.

In one example, the displaying system (110) further identifies additional representative items (210) for a collection of items. In this example, the additional representative item (210) for a collection of items may be additional representative item one (210-1) and additional representative item two (210-2). In this example, additional representative item one (210-1) may be an image of a wedding cake and additional representative item two (210-2) may be a video of how a wedding flower bouquet is designed.

In one example, if the user is the author of board one (222-1), edit button one (220-1) is displayed to the user. Edit button one (220-1) may be used to allow the user to add items, delete items, rearrange items in the collection of items. Alternatively, the user is not the author of board one (222-1), edit button one (220-1) is not displayed to the user.

Similarly, in this example, board two (222-2) includes header two (218). Header two (218) corresponds to a topic for board two (222-2). For example, header two (218) may be a title such as kids. Further, board two (222-2) may include representative item two (206). As mentioned above, the displaying system (110) of FIG. 1 identifies, based on the preference criteria for the user, a representative item for a collection of items. In this example, the preference criteria may include topics about kid's rooms. If the collection of items includes ideas for decorating a kid's room and images of kids, the displaying system of FIG. 1 displays a representative item accordingly. For example, the preference criteria for the user may indicate that the representative item for a collection of items is to be an image of a child's red wagon filled with children's books.

In one example, the displaying system (110) further identifies an additional representative item (212) for a collection of items. In this example, the additional representative item (212) for a collection of items may be additional representative item one (212-1) and additional representative item two (212-2). In this example, additional representative item one (212-1) may be a children's beds and additional representative item two (210-2) may be children's art.

In one example, if the user is the author of board two (222-2), edit button two (220-2) is displayed to the user. Edit button two (220-2) may be used to allow the user to add, delete, rearrange items in the collection of items. Alternatively, if the user is not the author of board two (222-2), edit button two (220-2) is not displayed to the user.

Similarly, in this example, board three (222-3) includes header three (220). Header three (220) corresponds to a topic for board three (222-3). For example, header three (220) may be a title such as desserts. Further, board three (222-3) may include representative item three (208). As mentioned above, the displaying system (110) of FIG. 1 identifies, based on the preference criteria for the user, a representative item for a collection of items. In this example, the preference criteria may include desserts at weddings. If the collection of items includes ideas for desserts and desserts served at weddings, the displaying system of FIG. 1 displays a representative item accordingly. For example, the preference criteria for the user may indicate that the representative item for a collection of items is to be an image of a wedding cake.

In one example, the displaying system (110) further identifies an additional representative item (214) for a collection of items. In this example, the additional representative item (214) for a collection of items may be additional representative item one (214-1) and additional representative item two (214-2). In this example, additional representative item one (214-1) may be a cookies served at a wedding and additional representative item two (214-2) may be a pie served at a wedding.

In one example, if the user is the author if board three (222-3), edit button three (220-3) is displayed to the user. Edit button three (220-3) may be used to allow the user to add, delete, rearrange items in the collection of items. Alternatively, if the user is not the author of board three (222-3), edit button three (220-3) is not displayed to the user.

While this example has been described with reference to displaying three boards, any number of boards may be displayed. For example, five boards may be displayed. Further, any appropriate number of representative items and additional representative items may be displayed within each board.

FIG. 2B is a diagram of an example of displaying a representative item for a collection of items to a user, according to one example of principles described herein. As mentioned above, an item associated with the collection of items that may be of interest to the user is displayed as a representative item. A user may click on the representative item to view the other items in the collection of items. As a result, the representative item for the collection of items is tailored to suit the interest of individual users. In this example, the representative item for the collection of items is tailored to suit the interest of the user in FIG. 2A. As will be described below, FIG. 2B and FIG. 3B will maybe compared to illustrate that, the collection of items may be the same however, the representative item for each of the users is different.

As illustrated in FIG. 2B, a display (252) is used to display one board (262). The board (262) represents a collection of items that are displayed to a user.

In this example, the board (262) may include representative item one (254). As mentioned above, the displaying system (110) of FIG. 1 identifies, based on the preference criteria for the user, a representative item for a collection of items. As illustrated, the representative item one (254) may be a star.

In one example, the displaying system (110) further identifies additional representative items (260) for a collection of items. In this example, the additional representative item (260) for a collection of items may be additional representative item one (260-1), additional representative item two (260-2), and additional representative item three (260-3). As illustrated, additional representative item one (260-1) may be a heart. Additional representative item two (262-2) may be a smiley face. Additional representative item three (262-3) may be a sun.

While this example has been described with reference to displaying one board, any number of boards may be displayed. For example, five boards may be displayed. Further, any appropriate number of representative items and additional representative items may be displayed within each board.

FIG. 3A is a diagram of an example of displaying a representative item from a collection of items to a different user, according to one example of principles described herein. As mentioned above, an item associated with the collection of items that is of interest to the user to be displayed as a representative item. A user may click on the representative item to view the other items in the collection of items. As a result, the representative item for the collection of items is tailored to suit the interest of individual users. In the examples of FIG. 3A, the collection of items are the same as the collection of items of FIG. 2A, however, the representative item for the collection of items is tailored to suit the interest of the second user (108-2) of FIG. 1. In FIG. 3A, the term user is to be associated with the second user (108-2) of FIG. 1.

Through analyzing the history of interest of the user, the user is married, has kids, and loves chocolate. As a result, the user preference for the second user indicates that the user is interested in topics about marriage, kids, and chocolate.

As illustrated in FIG. 3A, a display (302) is used to display a number of boards (322). In this example, three boards, namely board one (322-1) board two (322-3) and board Three (322-3) are displayed. The boards (322) represent a collection of items that are displayed to a user.

In this example, board one (322-1) includes header one (316). The header (316) corresponds to a topic for board one (322-1). For example, header one (316) may be a titles such as photo ideas. Further, board one (322-1) may include representative item one (304). As mentioned above, the displaying system (110) of FIG. 1 identifies, based on the preference criteria for the user, a representative item for a collection of items. In this example, the preference criteria may include topics relating to kids. If the collection of items includes items relating to weddings and kids, the displaying system of FIG. 1 displays a representative item accordingly. For example, the preference criteria for the user may indicate that the representative item for a collection of items is to be an image of a kid playing with toys.

In one example, displaying system (110) further identifies an additional representative item (310) for a collection of items. In this example, the additional representative item (310) for a collection of items may be additional representative item one (310-1) and additional representative item two (310-2). In this example, additional representative item one (310-1) may be a URL for kids cloths and additional representative item two (210-2) may be a video of Christmas with kids.

In one example, if the user is the author if board one (322-1), edit button one (320-1) is displayed to the user. Edit button one (320-1) may be used to allow the user to add, delete, rearrange items in the collection of items. Alternatively, if the user is not the author of board one (322-1), edit button one (320-1) is not displayed to the user.

Similarly, in this example, board two (322-2) includes header two (318). Header two (318) corresponds to a topic for board two (322-2). For example, header two (318) may be titled kids. Further, board two (322-2) may include representative item two (306). As mentioned above, the displaying system (110) of FIG. 1 identifies, based on the preference criteria for the user, a representative item for a collection of items. In this example, the preference criteria may include topics for decorating a kid's room. If the collection of items includes ideas for decorating a kid's room and images of kids, the displaying system of FIG. 1 displays a representative item accordingly. For example, the preference criteria for the user may indicate that the representative item for a collection of items is to be an image of an image of children's bunk beds.

In one example, displaying system (110) further identifies an additional representative item (312) for a collection of items. In this example, the additional representative item (312) for a collection of items may be additional representative item one (312-1) and additional representative item two (312-2). In this example, additional representative item one (312-1) may be a red wagon filled with children's books and additional representative item two (310-2) may be children's art.

In one example, if the user is the author if board two (322-2), edit button two (320-2) is displayed to the user. Edit button two (320-2) may be used to allow the user to add, delete, rearrange items in the collection of items. Alternatively, if the user is not the author of board two (322-2), edit button two (320-2) is not displayed to the user.

Similarly, in this example, board three (322-3) includes header three (320). Header three (320) corresponds to a topic for board three (322-3). For example, header three (320) may be titled desserts. Further, board three (322-3) may include representative item three (308). As mentioned above, the displaying system (110) of FIG. 1 identifies, based on the preference criteria for the user, a representative item for a collection of items. In this example, the preference criteria may include topics for desserts with chocolate. If the collection of items includes desserts with chocolate, the displaying system of FIG. 1 displays a representative item accordingly. For example, the preference criteria for the user may indicate that the representative item for a collection of items is to be an image of chocolate chip cookies.

In one example, displaying system (110) further identifies an additional representative item (314) for a collection of items. In this example, the additional representative item (314) for a collection of items may be additional representative item one (314-1) and additional representative item two (314-2). In this example, additional representative item one (314-1) may be a chocolate candy bars and additional representative item two (314-2) may be chocolate cake.

In one example, if the user is the author if board three (322-3), edit button three (320-3) is displayed to the user. Edit button three (320-3) may be used to allow the user to add, delete, rearrange items in the collection of items. Alternatively, if the user is not the author of board three (322-3), edit button three (320-3) is not displayed to the user.

While this example has been described with reference to displaying three boards associated with three collections of items, any number of boards may be displayed. For example, five boards may be displayed. Further, any appropriate number of representative items and additional representative items may be displayed within each board for the collection of items.

FIG. 3B is a diagram of an example of displaying a representative item for a collection of items to a user, according to one example of principles described herein. As mentioned above, an item associated with the collection of items that may be of interest to the user is displayed as a representative item. A user may click on the representative item to view the other items in the collection of items. As a result, the representative item for the collection of items is tailored to suit the interest of individual users. In this example, the representative item for the collection of items is tailored to suit the interest of the user in FIG. 3A. As will be described below, FIG. 2B and FIG. 3B will maybe compared to illustrate that, the collection of items may be the same however, the representative item for each of the users is different.

As illustrated in FIG. 3B, a display (352) is used to display one board (362). The board (362) represents a collection of items that are displayed to a user as well as additional information.

In this example, the board (362) may include representative item one (354). As mentioned above, the displaying system (110) of FIG. 1 identifies, based on the preference criteria for the user, a representative item for a collection of items. As illustrated, the representative item one (354) may be a sun.

In one example, the displaying system (110) further identifies additional representative items (360) for a collection of items. In this example, the additional representative item (360) for a collection of items may be additional representative item one (360-1), additional representative item two (360-2), and additional representative item three (360-3). As illustrated, additional representative item one (360-1) may be a heart. Additional representative item two (262-2) may be a star. Additional representative item three (262-3) may be a smiley face.

When FIG. 3B is compared to FIG. 2B, the collection of items may be the same, that is, the collection of items includes a sun, a heart, a star, and a smiley face. However, the representative item for each of the users is different as well as the order of the additional representative items.

While this example has been described with reference to displaying one board, any number of boards may be displayed. For example, five boards may be displayed. Further, any appropriate number of representative items and additional representative items may be displayed within each board.

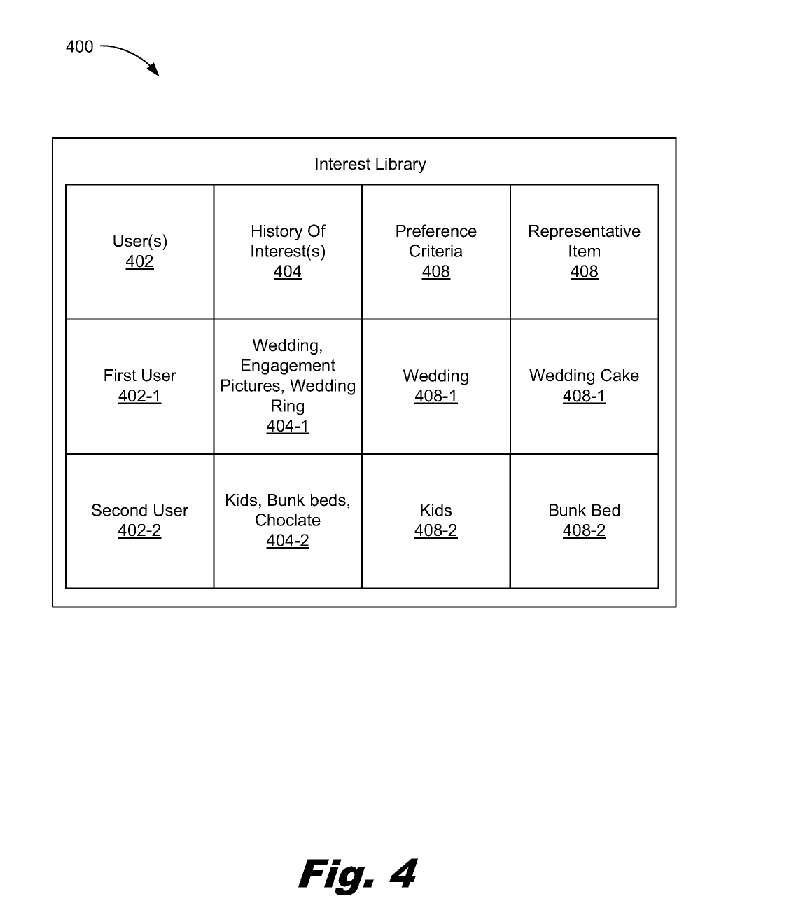

FIG. 4 is a diagram of an example of an interest library, according to the principles described herein. As mentioned above, an interest library may store, in memory, information about users who access the social media website as described in FIG. 1.

As illustrated in FIG. 4, the interest library (400) includes a number of users (402). In this example, a first user (402-1) and second user (402-2). As mentioned above, the displaying system of FIG. 1 obtains, from at least one source, a history of interests (404) associated with a user. In this example, a history of interests that includes content about wedding, engagement, pictures, wedding ring (404-1) may be obtained and associated with the first user (402-1). Similarly, a history of interests that includes content about kids, bunk beds, and chocolate (404-2) may be obtained and associated with the second user (402-2).

As mentioned above, the displaying system of FIG. 1 analyzes the history of interests (404) associated with the user to determine preference criteria for the user. As illustrated, the interest library (400) may include preference criteria for the users (402-1). For example, the first user's preference criteria may be wedding (408-1). Further, the second user's preference criteria may be kids (408-2). If the first user (402-1) is going to view a collection of items that includes images such as wedding cake, clown, chair, rug, light fixtures, bunk beds, the displaying system of FIG. 1 identifies, based on the preference criteria for the first user (402-1), a representative item for a collection of items. In this example, the representative item (408) may be a wedding cake (408-1) that is to be displayed to the first user (402-1). As a result, the displaying system of FIG. 1 displays, to the first user (402-1), the wedding cake (408-1) as the representative item on, for example, a social media website.

Similarly, if the second user (402-2) is going to viewing the same collection of items that includes images such as wedding cake, clown, chair, rug, light fixtures, bunk beds (406-2), the displaying system of FIG. 1 identifies, based on the preference criteria for the second user (402-2), a representative item for a collection of items. In this example, the representative item (408) may be a bunk bed (408-2) for the second user (402-2). As a result, the displaying system of FIG. 1 displays, to the second user (402-2), the bunk bed (408-2) as the representative item on, for example, the social media website.

While this example has been described with reference to the interest library including two users, the interest library may include any number of users. For example, twenty users. Further, the preference criteria for each user may not be limited to one topic as illustrated in FIG. 4.

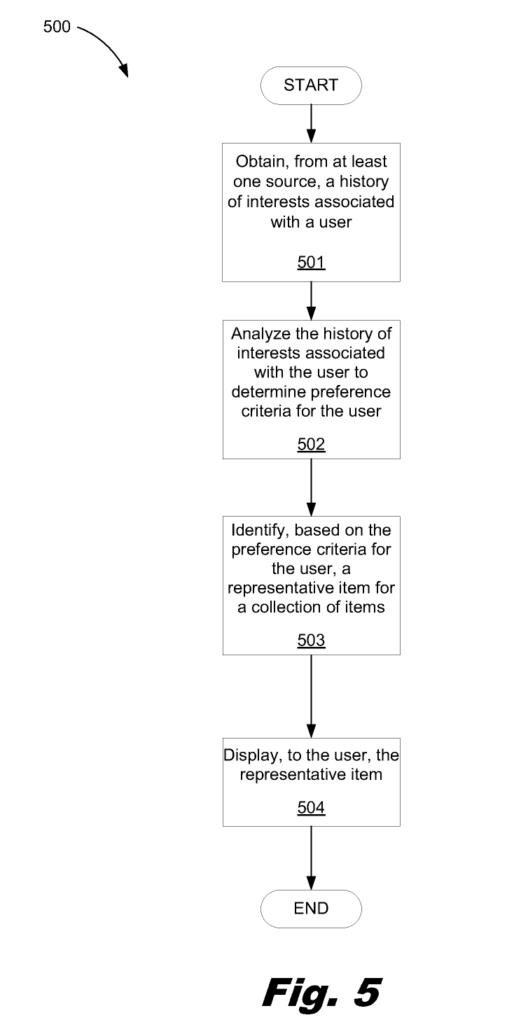

FIG. 5 is a flowchart of an example of a method for displaying a representative item from a collection of items, according to one example of principles described herein. In one example, the method (500) may be executed by the displaying system (100) of FIG. 1. In other examples, the method (500) may be executed by other system such as system 700 or system 800. In this example, the method (500) includes obtaining (501), from at least one source, a history of interests associated with a user, analyzing (502) the history of interests associated with the user to determine preference criteria for the user, identifying (503), based on the preference criteria for the user, a representative item for a collection of items, and displaying (504), to the user, the representative item.

As mentioned above, the method (500) includes obtaining (501), from at least one source, a history of interests associated with a user. In one example, the history of interests associated with a user may be obtained from sources such as a social media website, a search engine website, other websites, or combinations thereof.

Further, obtaining, from the at least one source, the history of interests associated with the user includes monitoring activities of the user and a similar user to capture explicit interests of the user, implicit interests of the user, explicit interests of the similar user, implicit interests of the similar user, or combinations thereof.

In one example, explicit interests of the user may be captured when a user likes a website, an image, a video, other media, or combinations thereof. In another example, explicit interests of the user may be captured when a user searches using a search engine. For example, if a user uses a search engine to search for chocolate, the user is explicitly indicating an interest in chocolate. In one example, the explicit interests of the user may be captured as content for the history of interests for the user.

In one example, implicit interests of the user may be captured when a user updates personal information. For example, if a user indicates that he is now engaged, this implicit interest allows the displaying system of FIG. 1 to determine that topics about wedding are of interest to the user. In one example, the implicit interests of the user may be captured as content for the history of interests for the user.

In one example, a collection of items may not include an item that may be of interest to the user. However, the collection of items may include an item that may be of interest to another user with similar interests of the user. In this example, the displaying system of FIG. 1 may capture explicit and implicit interest for another user that has similar tastes to the user. For example, if the user's best friend likes rock concerts, it is more than likely that the user will also like rock concerts. As a result, the displaying system of FIG. 1 may captures explicit and implicit interest for a user that has similar tastes to the user to as content for the history of interests for the user.

As mentioned above, the method (500) includes analyzing (502) the history of interests associated with the user to determine preference criteria for the user. In one example, analyzing the history of interests associated with the user to determine the preference criteria for the user includes applying a NLP to content within the history of interests to characterize the content. In one example, the NPL enables the displaying system of FIG. 1 to derive meaning from the content within the history of interests. In one example, the content may be characterized categories such as topics, dates, themes, other categories or combinations thereof.

In another example, the content, such as an image, in the history of interests associated with the user may be analyzed using advanced methods and techniques for image recognition, the image's metadata, optical character recognition, other methods or combinations thereof. As a result, the content may be characterized using these methods and techniques.

As mentioned above, the method (500) includes identifying (503), based on the preference criteria for the user, a representative item for a collection of items. As mentioned above, if the preference criteria for the user indicate the user likes chocolate cake and the collection of items includes an image of a chocolate cake, the representative item for a collection of items may be a chocolate cake. In another example, if the preference criteria for the user indicate the user likes wedding ideas and the collection of items includes an image of flowers for a wedding, the representative item for a collection of items may be the image of flowers for a wedding.

In one example, the representative image may be identified using advanced methods and techniques for image recognition, the image's metadata, optical character recognition, other methods or combinations thereof. Further, the representative image may be identified based on a content-based approach. The content-based approach identifies items, such as an image, that the user has liked, on a social media website, in the past. For example, if the user liked several images of tigers in the past, the representative image that is identified would more than likely contain a tiger if the collection of items contained an image of a tiger.

Further, the representative image may be identified based on a collaborative filter approach. The collaborative filter approach identifies items that users with similar interests have liked, commented on, searched for, among others.

As mentioned above, the method (500) includes displaying (504), to the user, the representative item. In one example, one representative item may be displayed on the social media website. In another example, the representative items for the collection of items may be displayed on an application, other places, or combinations thereof. In another example, one representative item may be displayed on the social media website as well as several additional representative items. As a result, the representative item that is displayed to the user on a social media website is tailored to suit the interests of the user. Thus, the user is more likely to view the collection of items.

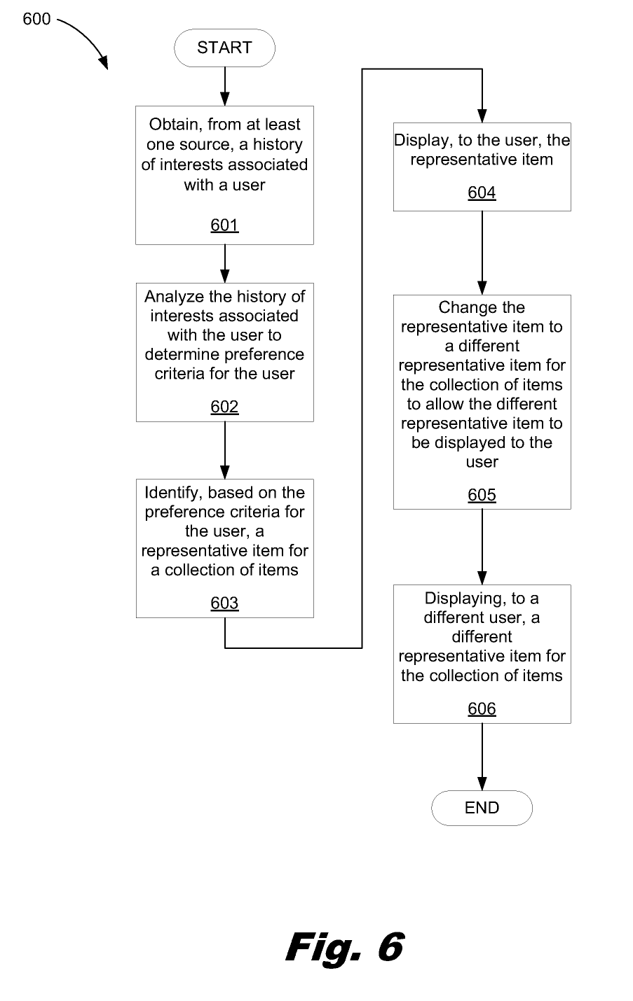

FIG. 6 is a flowchart of an example of a method for displaying a representative item from a collection of items, according to one example of principles described herein. In one example, the method (600) may be executed by the displaying system (100) of FIG. 1. In other examples, the method (600) may be executed by other system such as system 700 or system 800. In this example, the method (600) includes obtaining (601), from at least one source, a history of interests associated with a user, analyzing (602) the history of interests associated with the user to determine preference criteria for the user, identifying (603), based on the preference criteria for the user, a representative item for a collection of items, displaying (604), to the user, the representative item, changing (605) the representative item to a different representative item for the collection of items to allow the different representative item to be displayed to the user, and displaying (606), to a different user, a different representative item for the collection of items.

As mentioned above, the method (600) includes changing (605) the representative item to a different representative item for the collection of items to allow the different representative item to be displayed to the user, for example, on a social media website. In one example, changing the representative item to a different representative item for the collection of items allows the different representative item to be displayed to the user, for example, on the social media website. For example, if the preference criteria for the user indicate that the user is interested in both chocolate cake and chocolate chip cookies and the collection of items includes images of both chocolate cake and chocolate chip cookies, the representative item may be changed between the chocolate cake and chocolate chip cookies.

Further, changing the representative item to the different representative item for the collection of items may be changed according to a number of times the representative item is displayed to the user, may be changed randomly, may be changed based on a round robin, or combinations thereof.

For example, if the representative item has been viewed seven times by the user, the displaying system may change the representative item to the different representative. As a result, this allows the user to maintain interest in the collection of items.

In another example, the displaying system of FIG. 1 may change the representative item to the different representative randomly. For example, the randomness may be based on a time, a location, other factors, or combinations thereof. As a result, this allows the user to maintain interest in the collection of items.

In yet another example, the representative item may be changed to the different representative in a round robin. For example, if there are three representative items that can be displayed, the displaying system may display the first representative item, then the second representative items, then the third representative items. This pattern may repeat according to a time, an event, other factors, or combinations thereof. As a result, this allows the user to maintain interest in the collection of items.

As mentioned above, the method (600) includes displaying (606), to a different user, a different representative item for the collection of items. As mentioned above, the representative item for the collection of items is tailored to suit the interest of individual users. In one example, the different representative item for the collection of items is based on preference criteria for the different user. The preference criteria for the different user may be determined by the method of FIG. 5. In one example, a collection of items includes images of animals such as dogs and cats. In this example, two users, user A and user B may view the collection of items. If user A's preference criteria indicates that user A is interested in dogs, an image of a dog may be used as the representative item when user A is viewing the collection. However, if user B's preference criteria indicates that user B is interested in cats, an image of a cat may be used as the representative item when user B is viewing the collection. As a result, a different representative item for the collection of items is displayed to a different user, in this example, user B.

FIG. 7 is a diagram of an example of a displaying system, according to one example of principles described herein. The displaying system (700) includes an obtaining engine (702), an analyzing engine (704), an identifying engine (706), and a representative item displaying engine (708). In this example, the displaying system (700) also includes a changing engine (710) and a different representative item displaying engine (712). The engines (702, 704, 706, 708, 710, 712) refer to a combination of hardware and program instructions to perform a designated function. Each of the engines (702, 704, 706, 708, 710, 712) may include a processor and memory. The program instructions are stored in the memory and cause the processor to execute the designated function of the engine.

The obtaining engine (702) obtains, from at least one source, a history of interests associated with a user. In one example, the obtaining engine (702) monitors activities of the user and a similar user to capture explicit interests of the user, implicit interests of the user, explicit interests of the similar user, implicit interests of the similar user, or combinations thereof. By monitoring activities of the user and the similar user the obtaining engine (702) obtains the history of interests associated with the user.

The analyzing engine (704) analyzes the history of interests associated with the user to determine preference criteria for the user. In one example, the analyzing engine (704) analyzes the history of interests associated with the user to determine the preference criteria for the user by applying a NLP to content within the history of interests to characterize the content.

The identifying engine (706) identifies, based on the preference criteria for the user, a representative item for a collection of items. In one example, the identifying engine (706) identifies, based on the preference criteria for the user, one representative item for a collection of items. In another example, the identifying engine (706) identifies, based on the preference criteria for the user, several representative items for a collection of items.

The representative item displaying engine (708) displays, to the user, the representative item. In one example, the representative item displaying engine (708) displays, to the user, one representative item on a social media website. In another example, the representative item displaying engine (708) displays, to the user, several representative items on the social media website. In other examples, the representative item displaying engine (708) displays, to the user, the representative item on an application, other places, or combinations thereof.

The changing engine (710) changes the representative item to a different representative item for the collection of items to allow the different representative item to be displayed to the user. In one example, the changing engine (710) changes the representative item to the different representative item for the collection of items according to a number of times the representative item is displayed to the user, changes the representative item to the different representative item for the collection of items randomly, changes the representative item to the different representative item for the collection of items based on a round robin, or combinations thereof.

The different representative item displaying engine (712) displays, to a different user, a different representative item for the collection of items. In one example, the different representative item for the collection of items is based on preference criteria for the different user.

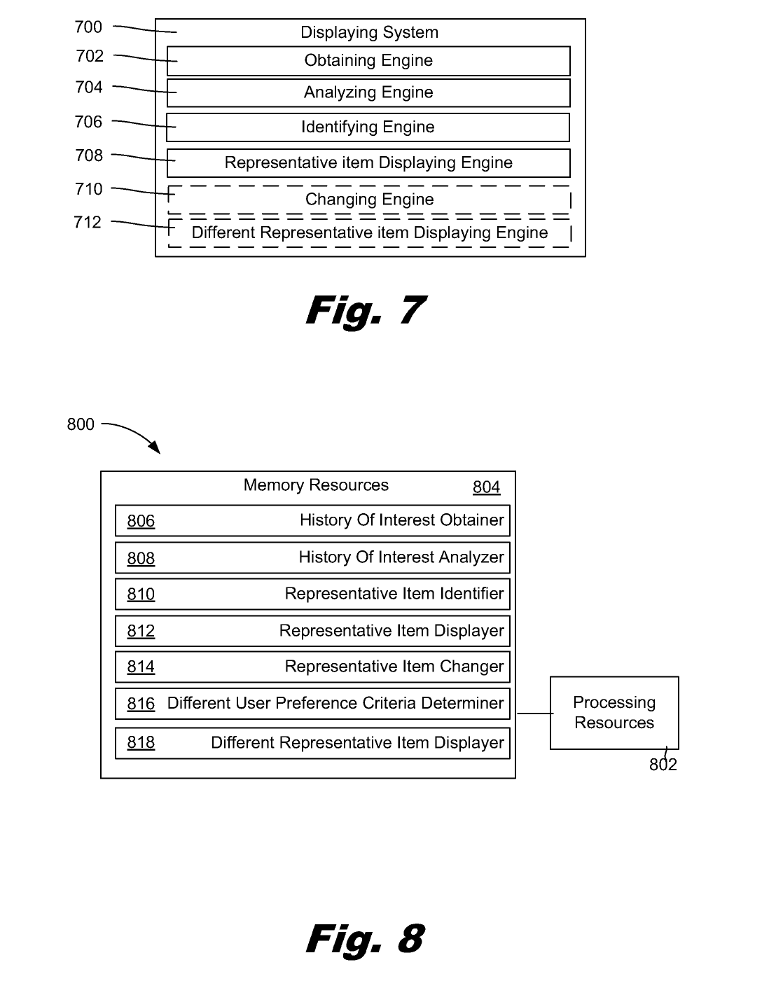

FIG. 8 is a diagram of an example of a displaying system, according to one example of principles described herein. In this example, displaying system (800) includes processing resources (802) that are in communication with memory resources (804). Processing resources (802) include at least one processor and other resources used to process programmed instructions. The memory resources (804) represent generally any memory capable of storing data such as programmed instructions or data structures used by displaying system (800). The programmed instructions shown stored in the memory resources (804) include a history of interest obtainer (806), a history of interest analyzer (808), a representative item identifier (810), a representative item displayer (812), a representative item changer (814), a different user preference criteria determiner (816), and a different representative item displayer (818).

The memory resources (804) include a computer readable storage medium that contains computer readable program code to cause tasks to be executed by the processing resources (802). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The history of interest obtainer (806) represents programmed instructions that, when executed, cause the processing resources (802) to obtain, from at least one source, a history of interests associated with a user. The history of interest analyzer (808) represents programmed instructions that, when executed, cause the processing resources (802) to analyze the history of interests associated with the user to determine preference criteria for the user.

The representative item identifier (810) represents programmed instructions that, when executed, cause the processing resources (802) to identify, based on the preference criteria for the user, a representative item for a collection of items. The representative item displayer (812) represents programmed instructions that, when executed, cause the processing resources (802) to display, to the user, the representative item.

The representative item changer (814) represents programmed instructions that, when executed, cause the processing resources (802) to change the representative item to a different representative item for the collection of items to allow the different representative item to be displayed to the user. The different user preference criteria determiner (816) represents programmed instructions that, when executed, cause the processing resources (802) to determine preference criteria for a different user. The different representative item displayer (818) represents programmed instructions that, when executed, cause the processing resources (802) to display, to a different user, a different representative item for the collection of items.

Further, the memory resources (804) may be part of an installation package. In response to installing the installation package, the programmed instructions of the memory resources (804) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (802) and the memory resources (804) are located within the same physical component, such as a server, or a network component. The memory resources (804) may be part of the physical component's main memory, caches, registers, non-volatile memory, or elsewhere in the physical component's memory hierarchy. Alternatively, the memory resources (804) may be in communication with the processing resources (802) over a network. Further, the data structures, such as the libraries, may be accessed from a remote location over a network connection while the programmed instructions are located locally. Thus, displaying system (800) may be implemented on a user device, on a server, on a collection of servers, or combinations thereof.

The displaying system (800) of FIG. 8 may be part of a general purpose computer. However, in alternative examples, the displaying system (800) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1. A method for displaying a representative item for a collection of items, the method comprising:
obtaining, from at least one source, a history of interests associated with a user;
analyzing the history of interests associated with the user to determine preference criteria for the user;
identifying, based on the preference criteria for the user, a representative item for a collection of items; and
displaying, to the user, the representative item.

2. The method of claim 1, in which analyzing the history of interests associated with the user to determine the preference criteria for the user comprises applying a natural language processing (NLP) to content within the history of interests to characterize the content.

3. The method of claim 1, further comprising changing the representative item to a different representative item for the collection of items to allow the different representative item to be displayed to the user.

4. The method of claim 3, in which changing the representative item to the different representative item for the collection of items to allow the different representative item to be displayed to the user comprises changing the representative item to the different representative item according to a number of times the representative item is displayed to the user, changing the representative item to the different representative item randomly, changing the representative item to the different representative item based on a round robin, or combinations thereof.

5. The method of claim 1, in which the collection of items comprises images, uniform resource locators (URL), messages, videos, audio, or combinations thereof.

6. The method of claim 1, in which obtaining, from the at least one source, the history of interests associated with the user comprises monitoring activities of the user and a similar user to capture explicit interests of the user, implicit interests of the user, explicit interests of the similar user, implicit interests of the similar user, or combinations thereof.

7. The method of claim 1, further comprising displaying, to a different user, a different representative item for the collection of items.

8. The method of claim 7, in which the different representative item for the collection of items is based on preference criteria for the different user.
